(19) United States
(12) Patent Application Publication
(10) Pub. No.: US 2006/0115566 A1
(43) Pub. Date: Jun. 1, 2006

(54) Preparation of liquid dough

(76) Inventors: Kurt Bloechlinger, Kemptthal (CH); Anders Ekberg, Bjuv (SE); Rudolf Hartmann, Turbenthal (CH)

Correspondence Address: BELL, BOYD & LLOYD LLC, P. O. BOX 1135, CHICAGO, IL, 60690-1135, US

(21) Appl. No.: 10/559,302

(22) PCT Filed: May 27, 2004
(86) PCT No.: PCT/EP04/05700

§ 371 Date: Dec. 2, 2005

(30) Foreign Application Priority Data
Jun. 4, 2003 (EP) 03012746.8

(51) Int. Cl. A21D 10/00

(52) U.S. Cl. 426/549

(57) ABSTRACT

Liquid dough whose Aw is less than 0.9 and which comprises 10 to 40% flour, from 20 to 30% fat, from 10 to 30% water, up to 2% salt and a mixture of at least one carbohydrate with low or zero sweetening power in a sufficient quantity to reduce the Aw of said dough to a desired value of less than 0.9. The dough substantially contains no carbohydrate having a substantially perceptible sweetening power and as a result does not have a sweet taste. This dough allows the production of savory bakery products such as fruit cakes with olives, lardoons or cheese for example. The dough can be preserved for several weeks in the refrigerated state and exists in liquid or fluid form which makes it possible to pour it directly into baking molds. Process for the manufacture of such a dough.

### BACKGROUND

The present invention relates to the field of liquid doughs, which can be preserved refrigerated for several weeks, which are ready to bake and which are intended for the production of savory bakery or Viennese products of the savory fruit cake, snack or stuffed bread type, for example.

Cakes, bread rolls, fruit cakes, muffins, Madeleines and other similar products are generally prepared from a mixture of pulverulent ingredients to which liquids such as milk, water or egg are added so as to obtain a fluid dough which is then poured into molds for baking.

The production of stuffed bread rolls, savory fruit cakes or other savory bakery products involves the making of a dough which is fluid to a greater or lesser degree, consisting of a mixture of flour, fat, salt, leavening agent liquids and optionally eggs. Ingredients such as meat, cheese, ham or vegetables in pieces or any other type of taste-enhancing and/or flavoring ingredients may be added to the dough. The preparation is then poured into molds and the whole is baked in an oven in a traditional manner. The liquid dough obtained, which serves for the production of such products, usually can only be preserved in the refrigerator for a limited period. Indeed, by virtue of its composition, such a dough is particularly sensitive to the development of bacteria and its preservation is limited to one or two days. Furthermore, although such a manner of proceeding makes it possible to obtain baked products of very good quality, the preparation of such a dough at the time of the production of these articles is sometimes felt as a constraint or even as an obstacle by the consumer because it is necessary to have available all the ingredients, to mix them in the right quantity while furthermore avoiding the formation of lumps, and the like. In addition, the production of such a dough generally takes some time for preparation without counting the rest time which is often necessary for this type of product.

Dehydrated premixes exist on the market which can be used for producing doughs by simply adding a given quantity of liquid followed by mixing. These products can generally be preserved without any problem; nevertheless, they do not make it possible to dispense with the mixing and rest stages which, as explained above, are often perceived by the consumer as an obstacle.

Cake dough products which are ready to bake, refrigerated or stable at room temperature have been described. They are mainly products whose preservation is due to the use of chemical preservatives. For some other products, stability during preservation is achieved by drastic reduction in the water activity (Aw) of the product to values of the order of 0.9 and below.

U.S. Pat. No. 6,217,929 describes a supple but nonpourable dough comprising 20 to 30% sugar so as to reduce its Aw below 0.92. Said dough is intended for refrigerated preservation.

The sugary nature of such products and of the pastry products for whose manufacture they are intended makes it possible easily to regulate this Aw by adding large quantities of sugar which acts simultaneously as taste-enhancing ingredient, bulking agent and Aw reducing agent.

Patent applications EP 0 275 878 and U.S. Pat. No. 4,803,084 describe doughs stable at room temperature whose preservation is achieved by an Aw value of less than or equal to 0.75.

However, the larger the quantity of sugar necessary for reducing the Aw, the thicker and the more viscous the dough obtained and, consequently, the more difficult it is to pour.

Patent application EP 1 249 170 describes a nonpourable snack, in which the filling consists of a dough having an Aw of between 0.85 and 0.95, the water content of said dough is between 25 and 35% and the reduction in Aw is achieved by glucose syrup.

While the use of sugar of the sucrose, glucose or invert sugar type with the aim of reducing the Aw of a mixture for cakes and other pastry products is possible or even desirable from the organoleptic point of view, the same is not true as regards the preparation of liquid doughs for the manufacture of savory products or of products intended to accompany savory dishes. Indeed, it is not conceivable to use a cake dough containing 20 to 30% sucrose for the preparation of a fruit cake with olives and lardoons or for the preparation of bread rolls with cheese and ham.

Indeed, from a taste point of view, the only quantity of sugar acceptable for liquid doughs intended for the production of this type of finished products with a predominantly savory taste can only be of the order of 2 to 3% at the most. Such a sugar content nevertheless does not make it possible to obtain an Aw sufficient for the refrigerated preservation of the product over a period of up to several days, let alone several weeks. Finally, the use of cooking salt (NaCl) alone for reducing the Aw to the required level would involve incorporating such a quantity of salt into the dough that the product would simply be unfit for consumption because it is excessively savory.

A need therefore exists for a liquid dough that solves these problems, and the aim of the present invention is precisely to provide a liquid or fluid dough which can be preserved for several weeks in the refrigerator, which has a neutral taste that is not substantially sweet, which is even slightly savory, and which can serve as a base for the production of savory fruit cakes, bread and bread rolls with or without addition of savory taste-enhancing ingredients such as ham, lardoons, cheese, olives or onions for example.

### SUMMARY

To this effect, the present invention relates to a fluid dough, which can be preserved refrigerated for several weeks, comprising about 10 to about 40% flour, about 10 to 30% water, about 20 to 30% fat, up to about 2% salt and a quantity of mixture of at least one carbohydrate with low or substantially zero sweetening power, sufficient to reduce the Aw of said dough to a value of less than 0.90.

The dough according to the invention is indeed sufficiently liquid or fluid to be poured directly into a mold or supplemented beforehand with solid and flavoring ingredients and auxiliary agents such as ham cubes, olive or onion pieces or lardoons for example.

Despite its fluidity, the dough according to the invention has an Aw of less than 0.90, preferably of less than 0.89 and more preferably of less than 0.88. Such an Aw value allows preservation of the liquid dough according to the invention in the refrigerated state for a period which may be up to 4 or 6 weeks, without observing deterioration of its organoleptic qualities or growth of harmful bacteria. Indeed, after 4 weeks of storage in the refrigerated state, the dough according to the invention is not at all degraded, in particular the total aerobic mesophilic flora count is in a range below about 100 000 CFU/g, preferably below 10 000 CFU/g. In addition, the organoleptic qualities of the products obtained after baking said dough are remarkable. Indeed, at any stage of storage, the dough according to the invention makes it possible to obtain fruit cake or bread roll type products of very high quality, in particular having a particularly pleasant taste and texture. The packaging containing the dough according to the invention indeed simply has to be opened and the latter poured into a multiportion mold or into individual molds and a traditional baking carried out in a conventional convection oven in order to obtain said products. The baking may be carried out at a temperature of the order of 170 to 220° C., preferably from 180° to 200° C. and for a period ranging from 15 to 45 minutes, depending on the size of the molds. The baking may also be carried out in a microwave oven at a power of the order of 750 to 1000 W for a few minutes, this also depending on the size of the molds and the volume of the dough. Finally, it is also possible to envisage carrying out the baking of said dough according to the invention in a frying pan in a similar manner to a pancake or a galette.

### DETAILED DESCRIPTION

The expression refrigerated storage is understood to mean, in the context of the present application, a storage at a temperature of less than about 8° C. to 10° C., preferably less than about 5 to 8° C. and in any case greater than the freezing point of the product, that is to say about −2 to 0° C.

The dough according to the invention is liquid or fluid even at refrigeration temperatures as mentioned above. The consequence is that the dough can be directly used and poured into molds straight from the refrigerator.

In the context of the present application, the expression “liquid dough” is understood to mean a dough whose viscosity is as follows:

| Shear rate (1/s) | Viscosity (Pa · s) |
|---|---|
| 0.1 | 50-500 |
| 1 | 30-200 |
| 10 | 10-100 |
| 100 | 5 to 50 |

The measurements are carried out using a Physica UDS 200 rheometer equipped with a Couette geometry, in a forced stress mode, at a temperature of about 8° C. To obtain a homogeneous mass, the dough is mixed with the aid of a spoon before being poured into the vessel. The samples are subjected to 1 min of preshearing at 10 s⁻¹ and are then allowed to stand for 3 min. A logarithmic stress ramp ranging from 0.1 Pa to 2000 Pa is then applied to the samples in order to determine their flow curve.

In addition, in the context of the present application, the term “dough” is understood to mean a composition as defined in claim 1, that is to say mainly based on flour and water and serving for the production of bakery products mainly by baking in an oven. Depending on the composition of the dough according to the present invention, it will be possible to obtain a product whose viscosity is between a thick pancake dough and a doughnut dough piece. In any case, whatever the name given to the dough according to the invention, it makes it possible to obtain baked products which are in every way similar to products obtained with preparations having larger quantities of free water.

In the remainder of the description, the percentages are given by weight relative to the total weight of the composition, unless otherwise stated.

The flour contained in the dough according to the invention contributes toward giving structure and texture to the dough and to the baked product. A flour variety may be used, giving a variety of textures, tastes or appearances to the final product after baking. The flours which can be particularly used may be chosen from the group comprising hard or soft wheat flour, corn flour, more or less whole wheat flour or flour rich in amylose to a greater or lesser degree, alone or in combination. Wheat flour is more particularly preferred, in particular pastry flour having a protein content of less than about 11%, preferably of between 8 and 12% approximately. The proportions of the various flours can vary according to the desired product. The doughs according to the present invention contain about 10 to 40% flour, preferably 20 to 35%, more preferably 25 to 35% and more preferably still 29 to 34%.

The dough according to the present invention may additionally comprise an additional source of starch such as native or chemically or physically modified starches. Starches which can be used may be potato, wheat, rice and corn starches, for example, used alone or as a mixture.

The dough according to the present invention comprises about 20 to 30% fat. This fat is preferably fat which is liquid at room temperature, so as to facilitate the fluidity of the present dough. In particular, dietary vegetable oils such as sunflower, rapeseed, peanut or corn oil can be used, alone or as a mixture. The oils may be supplemented with vegetable fat but within the limit for obtaining a dough which retains its fluidity.

The dough according to the present invention may comprise a chemical leavening agent such as a traditional leavening powder composed of sodium diphosphate and sodium hydrogen carbonate. The quantity of leavening agent may be up to about 4%. The presence of leaving agent is not essential for good preservation or good fluidity of the product; it makes it possible to have an aerated and lighter final baked product. However, a liquid dough according to the invention without leavening agent may be suitable for the production of pancakes or galettes for example.

The dough according to the invention may additionally comprise emulsifiers such as phospholipids, mono/diglycerides and other esters of fatty acids and polyols and/or organic acids in a quantity which may be up to about 2%, as well as preservatives such as benzoic acid and its derivatives or other preservatives based on sorbate for example, in a quantity which may be up to about 2%.

The dough according to the present invention comprises a source of water. The water may thus be provided via tap water, milk, or a mixture of both for example. Alternatively, the milk may be provided only in powdered form. The quantity of water in the dough according to the invention is in a range from about 10 to about 30%.

The dough according to the invention may also comprise a source of egg product which may be either whole eggs, or liquid yolk or a mixture of yolk and egg white which have been pasteurized, as available commercially. Preferably, pulverulent products will be preferred for practical considerations, and the quantity of egg product in powdered form may be up to about 1%, preferably up to about 0.5% whole egg powder and up to about 5%, preferably up to about 4% egg white powder.

The dough according to the invention comprises a mixture of at least one scarcely sweetening or substantially nonsweetening carbohydrate which makes it possible to reduce the water activity by binding the free water and thus ensure the stability of the product while providing the least sweet taste in accordance with the application desired for the product. It has thus been possible, through the selection of at least one carbohydrate with low or zero sweetening power, to combine the free water binding function in order to reduce the Aw, and the bulking ingredient function while limiting the sweet taste of the product obtained. The lowering of the Aw contributes to the microbial stability necessary to confer stability on the product over long periods of storage in the refrigerated state.

The Aw of a food product is defined as the ratio of the vapor pressure of the water in a food system to the vapor pressure of pure water at the same temperature. The Aw values of the dough according to the invention are measured at room temperature using the dew point technique on a mirror cooled with the aid of a Decagon Aqualab model CX-2 apparatus, using the method of measurement recommended by the manufacturer. This apparatus is equipped with 2 sensors: an infrared temperature sensor and an optical sensor which make it possible to detect the moment when condensation appears. Knowing that the doughs according to the invention are preserved at refrigeration temperatures, an equilibration time at room temperature will be provided for before carrying out the measurement.

In general, the doughs according to the present invention have an Aw of between about 0.85 and about 0.90, preferably between about 0.86 and 0.88. If the water activity is too high, then microbial stability is not achieved. If on the other hand the Aw is too low, microbial stability is satisfactory but, on the one hand, the dough is too viscous, which makes it difficult to pour, and on the other hand, it is possible for the baked products not to have the desired texture and volume and to be furthermore excessively dry.

In the context of the present invention, the expression “carbohydrate with low or zero sweetening power” will be understood to mean carbohydrates whose sweetening power, as defined relative to the value 1 for the sweetening power of sucrose, is less than about 0.5, preferably less than 0.3 and preferably still less than 0.2. The sweetening power of a sugar, or of a carbohydrate in general, is a value between 0 and 1 defined as being representative of the intensity of the sweet taste of said carbohydrate, in solution in water at 1 g/l, this being in comparison with sucrose which, under the same conditions, has a sweetening power defined as being equal to 1.

Suitable carbohydrates may be chosen from the group comprising polysaccharides comprising at least three saccharide units, that is to say polysaccharides and their degradation products such as glucose syrups or maltodextrins or hydrogenated polysaccharides and their degradation products such as hydrogenated glucose syrups. Other polysaccharides may be used in combination with those mentioned above, in particular polyols with low sweetening power such as sorbitol or glycerol for example. Sorbitol and/or glycerol may be combined with those mentioned above, individually or as a mixture, this being in a quantity of up to 7%, preferably up to 5%.

In particular, maltodextrins have proved to be ingredients which are particularly suitable for the product according to the present invention. Indeed, they have little or no sweet taste and make it possible, when they are used in a suitable quantity, to reduce the Aw in a satisfactory manner without however increasing the viscosity of the dough so as to reduce its pourability to zero. In the context of the present invention, maltodextrins are products of the hydrolysis of starch to glucose syrup and have a DE (dextrose equivalent) of less than about 30. The DE (Dextrose Equivalent) is defined as the percentage of solids converted to reducing sugars.

The maltodextrins entering into the composition of the dough according to the present invention may be chosen from the group comprising maltodextrins with a DE of between about 10 and 30, preferably between about 15 and 25 and preferably still between 20 and 25, used alone or as a mixture. Preferably, a maltodextrin marketed by the company Roquette under the trademark Glucidex® whose DE is between about 20 to 23, is particularly suitable for the present invention.

The dough according to the invention therefore comprises a quantity of a mixture of at least one carbohydrate suitable for reducing the Aw to the desired value, that is to say a quantity of about 5% to 25%, preferably 5% to 20%, and more preferably still 5% to 15%. These quantities relate to the total quantity of carbohydrates contained in said mixture, knowing that several types of carbohydrates, polysaccharides and/or degradation products, hydrogenated polysaccharides and/or degradation products, and polyols may be used.

Indeed, several types of carbohydrate may be combined and used as a mixture and may enter into the composition of the dough according to the present invention, bearing in mind that the total mixture of at least one selected carbohydrate should only have a low sweetening power, that is to say less than 0.5, preferably less than 0.3 and still more preferably less than 0.2.

The quantity of mixture of at least one carbohydrate contained in the dough according to the invention will depend on the sweetening power/water activity reducing power combination while retaining a dough viscosity allowing it to be poured.

During the combination of several carbohydrates, it will be possible to envisage supplementing the maltodextrins, which remain the preferred source of carbohydrates, with other types of carbohydrate such as glucose syrups having a DE which is not very high (20 to 35) or which is intermediate (35 to 55) in a quantity, relative to the total weight of maltodextrins, of the order of 0 to 50%. This combination of various carbohydrates is conceivable with the proviso that the sweetening power of the mixture of these various carbohydrates allows its use in the context of the present invention, namely a sweetening power of said mixture of less than 0.5, preferably of less than 0.3 and still more preferably less than 0.2.

Thus, by virtue of the low Aw of the product according to the invention, it is possible to achieve storage in the refrigerated state for several weeks. The product preserves all its initial characteristics and organoleptic qualities which are identical to a dough freshly prepared at the time of use.

By virtue of the choice of carbohydrates of the dough according to the invention, the present application makes it possible to provide a dough without a sweet taste, or which cannot be substantially perceived, which is therefore ideal for the production of typically savory products such as fruit cakes or bread rolls which have been stuffed or comprise tasty ingredients such as cheese, ham, olives, lardoons, ham cubes, onions, for example. Other flavoring ingredients such as herbs, spices and flavorings may also be included in the dough according to the invention; they may be for example basil, parsley, garlic, coriander, pepper, curry, cumin, thyme or chives.

The high-fluidity characteristic of the dough has the advantage that, on the one hand, during its mixing with the bulking ingredients cited above, the latter can be mixed easily and with no effort with said dough and that, on the other hand, it is easy to pour the dough into a mold. The operations which remain the responsibility of the consumer are therefore reduced to the minimum, namely that of opening the packaging and of pouring the dough without any addition of essential ingredients or tedious handling. Indeed, although the dough is particularly well suited to the preparation of products containing various ingredients and solid and taste-enhancing auxiliary agents, it can very well serve for the direct production of plain savory fruit cakes or bread for accompanying other savory dishes.

The dough according to the invention may additionally comprise flavorings and may thus be available to the final consumer in flavored form in conformity with the culinary applications envisaged. The flavorings which may be envisaged, which the dough according to the present invention may contain, may be the following: olive, cheese, lardoons, tomato, for example. Finally, the ingredients which the consumer can add to the dough immediately before its use may be contained in said dough and the consumer now simply has to pour the contents of the packaging into one or more molds without any prior mixing.

It is observed that in this way, by virtue of the dough according to the present invention, numerous needs and expectations were able to be satisfied in the field of refrigerated culinary products intended for the direct production of snacks or other nonpastry, that is to say savory, bakery products.

The present invention also relates to a process for the manufacture of a fluid dough composition which can be preserved at refrigeration temperatures, said process comprising the steps of mixing 10 to 40% flour, 10 to 30% water, 20 to 30% fat, up to 2% salt and of adding a quantity of a mixture of at least one carbohydrate with low or substantially zero sweetening power, sufficient to reduce the Aw of said dough to a value of less than 0.90.

The process for the manufacture of the dough according to the present invention uses traditional equipment used in the food industry sector. It is in addition notable that by virtue of the formulation of the present dough, no heat treatment step is required in order to achieve stability of the finished product. In general, in the process according to the present invention, the pulverulent ingredients are mixed beforehand at a speed which is not very high, in a turning barrel of the Rönrad mixing barrel type for example in order to obtain a homogeneous whole. This premixing step promotes more particularly the homogeneous distribution of the leavening powder which may be present. The liquids are poured into the principal mixer and the pulverulent ingredients are then added. The mixers, used individually or combined, containing the following mixing aggregates are particularly suitable for this type of application: mixer-scraper, homogenizer, turbohomogenizer, dispersing device or mixer of the Hobart, Fryma, Stephan or Moltomat type for example. The mixing takes place at room temperature, the mixing time and speed being defined so as to obtain a homogeneous dough, without lumps. The mixing time is of the order of a few minutes. The dough is then transferred into an intermediate vessel, and then measured out into individual packagings of the Doypac® type with the aid of a piston pump. These packagings are of the flexible bag type made of plastic. As suitable packaging material, it is possible to use a multi-layer material such as PET 12-Met.PET 12-PE 120, for example. It goes without saying that any other type of packaging may be suitable, such as a nonflexible plastic dish or bowl for example. The final product is packaged under a modified atmosphere comprising CO₂, N₂, or a CO₂/N₂ combination. The gas or gases are injected into the packaging which is then heat sealed using a Thimmonier type metering and sealing equipment. The packagings may be cooled during passage through a cooling tunnel. The product cooling step may also take place before the packaging step. The sealed packagings are finally refrigerated, preferably at a temperature of less than 5° C. The refrigerated products obtained may be stored for several weeks, about 4 to 5 weeks, without impairment of their organoleptic or microbiological qualities.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A fluid dough, which can be preserved refrigerated for several weeks, comprising, as a percentage by weight, 10 to 40% flour, 10 to 30% water, 20 to 30% fat, up to 2% salt and a quantity of 5% to 25%, of at least one carbohydrate having low or substantially zero sweetening power, in order to reduce the Aw of the dough to a value of less than 0.90.

2. The dough as claimed in claim 1, wherein the at least one carbohydrate has a sweetening power which is less than 0.5.

3. The dough as claimed in claim 1, wherein it has a viscosity of between 5 and 500 Pa·s for shear rates of between 0.1 and 100 s⁻¹, at a temperature of 8° C.

4. The dough as claimed in claim 1, wherein the fat is a fat which is liquid at room temperature.

5. The dough as claimed in claim 1, wherein the at least one carbohydrate is selected from the group consisting of polysaccharides comprising at least three saccharide units and their degradation products, glucose syrups, maltodextrins, hydrogenated polysaccharides and their degradation products, and polyols, used alone or as a mixture.

6. The dough as claimed in claim 1, wherein the at least one carbohydrate is selected from the group comprising polysaccharides whose DE is between 10 and 30.

7. The dough as claimed in claim 1, wherein the at least one carbohydrate is maltodextrin.

8. The dough as claimed in claim 7, wherein the maltodextrins are supplemented with glucose syrups selected from the group consisting of glucose syrups having a DE of between 20 and 35, of the quantity of maltodextrins.

9. The dough as claimed in claim 7, comprising glycerol and/or sorbitol.

10. A process for the manufacture of a fluid dough composition which can be preserved at refrigeration temperatures, comprising the steps of mixing 10 to 40% flour, 20 to 30% fat, 10 to 30% water, up to 2% salt and adding a mixture of at least one carbohydrate with a low or substantially zero sweetening power, sufficient to reduce the Aw of said dough to a value of less than 0.90.

11. The dough as claimed in claim 1, comprising 5% to 20% of the at least one carbohydrate.

12. The dough as claimed in claim 1, comprising 5% to 15% of the at least one carbohydrate.

13. The dough as claimed in claim 1, wherein the at least one carbohydrate has a sweetening power which is less than 0.3.

14. The dough as claimed in claim 1, wherein the at least one carbohydrate has a sweetening power which is less than 0.2.

15. The dough as claimed in claim 1, wherein the at least one carbohydrate is selected from the group consisting of polysaccharides whose DE is between 15 and 25.

16. The dough as claimed in claim 1, wherein the at least one carbohydrate is selected from the group consisting of polysaccharides whose DE is between 20-25.

17. The dough as claimed in claim 7, wherein the maltodextrins are supplemented with glucose syrups selected from the group consisting of glucose syrups having a DE of between 35 and 55, up of the quantity of maltodextrins.
